(19) United States
(12) Patent Application Publication
(10) Pub. No.: US 2018/0080772 A1
(43) Pub. Date: Mar. 22, 2018

(54) SYSTEMS AND METHODS OF NAVIGATION USING A SEXTANT AND AN ELECTRONIC ARTIFICIAL HORIZON

(71) Applicant: Kenneth Michael Beck, Seattle, WA (US)

(72) Inventor: Kenneth Michael Beck, Seattle, WA (US)

(21) Appl. No.: 15/705,515

(22) Filed: Sep. 15, 2017

Related U.S. Application Data
(60) Provisional application No. 62/396,028, filed on Sep. 16, 2016.

(51) Int. Cl. G01C 21/02; G01C 1/10; G01S 5/08

(52) U.S. Cl. CPC G01C 21/025; G01S 5/08; G01C 1/10

(57) ABSTRACT

Systems and methods for navigation using a sextant and an electronic artificial horizon are disclosed herein. In one embodiment, a method for determining a position of an observer includes: establishing a horizontal position of an artificial horizon mirror based on at least one accelerometer; aligning a sextant toward a celestial body; and measuring an altitude angle of the celestial body at least in part based on a portion of light from the celestial body being reflected from the artificial horizon mirror onto the sextant.

### CROSS-REFERENCE(S) TO RELATED APPLICATION(S)

This application claims the benefit of U.S. Provisional Application No. 62/396028, filed on Sep. 16, 2016, which is hereby incorporated by reference in its entirety.

### BACKGROUND

A sextant is a doubly reflecting navigation instrument that measures the angular distance between two visible objects. Typically, one object being observed is a celestial body (e.g., the Sun, the Moon, a star, etc.) and the other object is a horizontal surface (e.g., water surface). Therefore, the sextant measures an angle between the celestial body and the horizon that reflects the image of that celestial body for the purposes of navigation. The measured angle, and the time of taking the measurement, can be used to estimate the latitude of the observer using the nautical charts or tables.

However, in some situations a suitable horizontal surface is not available. For example, the horizontal surfaces may not be available at high altitudes (e.g., on the mountains) or at high latitudes (e.g., close to the North or South poles), because the water surfaces, if any, may be frozen. Furthermore, the electronic GPS signal may also be unavailable or imprecise at high altitudes or latitudes.

In some prior art technologies, a reference horizontal surface may be based on a pool of mercury, because mercury remains liquid even at very low atmospheric temperatures. However, in many situations it is impractical and/or hazardous to carry a supply of mercury for generating the reference horizontal surface. Similar difficulties arise when other liquids, for example alcohol, are used for the reference horizontal surface.

Therefore, systems and methods for accurately determining location using a sextant are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a method for determining a position of an observer includes: establishing a horizontal position of an artificial horizon mirror based on at least one accelerometer; aligning a sextant toward a celestial body; and measuring an altitude angle of the celestial body at least in part based on a portion of light from the celestial body being reflected from the artificial horizon mirror onto the sextant.

In one aspect, the artificial horizon mirror is a screen of a mobile device.

In another aspect, the artificial horizon mirror is a reflective surface affixed to a mobile device.

In one aspect, the accelerometer is carried by the mobile device.

In one aspect, the mobile device is a mobile phone.

In another aspect, the mobile device is a tablet.

In one aspect, accelerometer comprises a 3-axis MEM accelerometer.

In one aspect, the method also includes determining a latitude and a longitude of the observer based on the altitude angle of the celestial body and a reference to predetermined positions of the celestial body.

In one aspect, establishing the horizontal position of the artificial horizon mirror includes: placing the artificial horizon mirror on a leveler; and adjusting an inclination of the leveler to bring the artificial horizon mirror into the horizontal position.

In one embodiment, a system for determining a position of an observer includes: an artificial horizon mirror having a determinable horizontal position based on at least one accelerometer; and a sextant configured to determine an altitude angle of the celestial body at least in part based on a portion of light from the celestial body being reflected from the artificial horizon mirror onto the sextant.

In one aspect, the system also includes a leveler for bringing the artificial horizon mirror into the horizontal position.

In one aspect, the leveler includes adjustable feet.

In one aspect, the artificial horizon mirror is a screen of a mobile device.

In one aspect, the screen of the mobile device includes indicators of the horizontal position of the mobile device.

In one aspect, the indicators of the horizontal position of the mobile device indicate that the position of the mobile device is the horizontal position.

In one aspect, the artificial horizon mirror is a reflective surface affixed to a mobile device.

In one aspect, the accelerometer includes a 3-axis MEM accelerometer.

### DESCRIPTION OF THE DRAWINGS

The foregoing aspects and many of the attendant advantages of the inventive technology will become more readily appreciated as the same become better understood by reference to the following detailed description, when taken in conjunction with the accompanying drawings, wherein:

FIG. 1 is a schematic view of a location determination by sextant in accordance with prior art technology.

FIG. 2 is a detail view of a sextant in accordance with prior art technology.

FIG. 3 is a schematic view of a 3D accelerometer in accordance with prior art technology.

FIGS. 4A and 4B are schematic views of a level detector in accordance with prior art technology.

FIG. 5 is a schematic view of a location determination in accordance with embodiments of the presently disclosed technology.

FIG. 6 is an isometric view of an artificial horizon in accordance with an embodiment of the presently disclosed technology.

### DETAILED DESCRIPTION

While illustrative embodiments have been described, it will be appreciated that various changes can be made therein without departing from the spirit and scope of the inventive technology. Briefly, in some embodiments, a sextant is used in conjunction with a reference horizon that is an electronic artificial horizon. Such electronic artificial horizon (also referred to as an “artificial horizon mirror”) may be based on an output of an accelerometer. In operation, the accelerometer outputs signals that are proportional to the acceleration, including the gravitational acceleration that is directed toward the center of the Earth. The gravitational acceleration is perpendicular to the surface of the Earth or to a body of water on the surface of the Earth. Therefore, the output of the accelerometer may determine an electronic artificial horizon.

In some embodiments, the accelerometer may be part of a smart phone, tablet, or other electronic device that is placed on an adjustable level table. Therefore, leveling such smart phone, tablet, etc., creates a horizontal surface of the device by aligning the direction of the accelerometer signal in the vertical direction.

Many such electronic devices include reflective screens. In some embodiments of the inventive technology, the visible light reflects from the screen of the electronic devices for a sufficiently small angle of the incoming light. Therefore, the screen of these electronic devices may function as a mirror-like device for the sufficiently small angle of the incoming light. Since the electronic device can be placed horizontally based on the accelerometer output, the reflective screen of the device may serve as an electronic artificial horizon. Next, the latitude and longitude of the observer can be determined using the angle measured by the sextant and the tabulated locations of known celestial bodies, e.g., tabulated position of the Sun, the Moon, stars, etc., as a function of date/time. An almanac, such as a nautical or aeronautical almanac of the Sun, the Moon, stars and planets is an example of such a listing of tabulated locations.

In some embodiments, the accelerometer can be a 3D accelerometer that provides acceleration signal in three directions. In some embodiments, the accelerometer may be a MEMS (Micro Electro-Mechanical System) accelerometer.

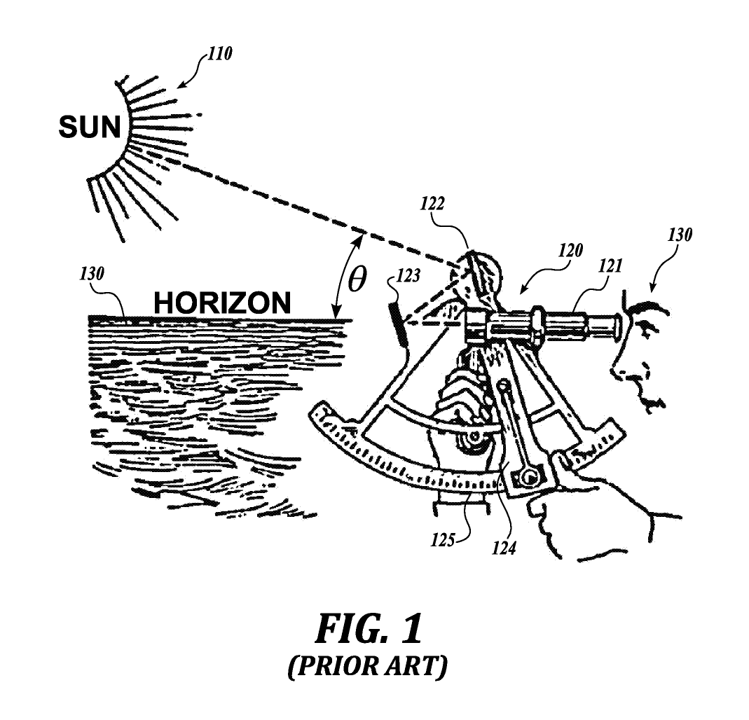

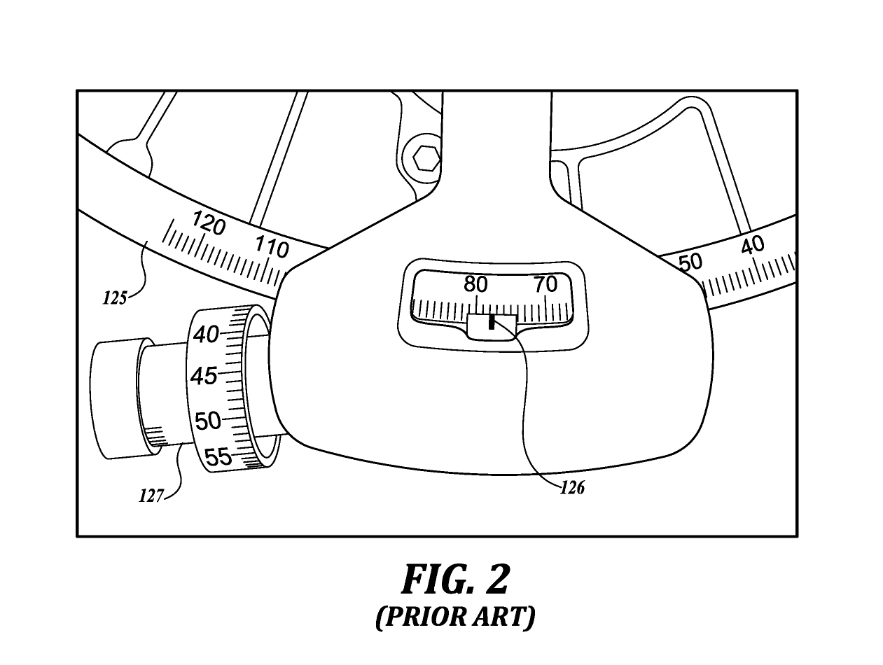

FIG. 1 is a schematic view of a location determination by a sextant 120 in accordance with prior art technology. In operation, a user 130 orients a sextant 120 toward a celestial object 110. Light from the celestial object 110 impinges onto an index mirror 122 that is rotatable along a graduated arc 125. Rotation of an arm 124 changes an angle θ of the index mirror 122. When the index mirror 122 is properly aligned against the incoming light from the celestial object 110, the user 130 observes two, mutually aligned images through a telescope 121: (i) an image of the celestial object 110 reflected through the index mirror 122 and (ii) an image of the celestial object 110 reflected through a partially reflective horizon mirror 123. The alignment of the two images indicates that the sextant 120 and the arm 124 are in their proper positions. Next, an altitude angle θ can be read off the graduated arc 125 as described with reference to FIG. 2 below.

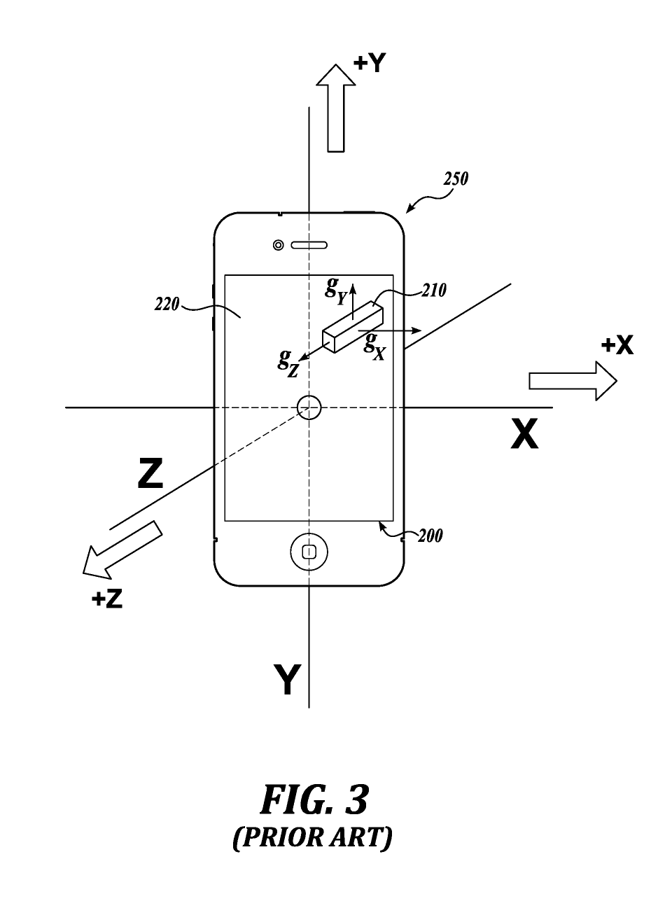

FIG. 2 is a detail view of the sextant 120 in accordance with prior art technology. Illustrated sextant 120 includes a coarse angle indicator 126 (e.g., indicating altitude angle θ degrees) and a fine angle indicator (e.g., indicating a sub-degree value of the altitude angle θ). In operation, the operator combines the two readings to come up with a complete value of the altitude angle θ.
FIG. 3 is a schematic view of a 3D accelerometer 210 in accordance with prior art technology. The accelerometer 210 may be a component of an electronic device 250 (e.g., a smart phone, tablet, etc.). An example of a 3D accelerometer is a LIS331DL 3-axis MEMS accelerometer.

In operation, the 3D accelerometer 210 generates signals that correspond to acceleration along X, Y and Z coordinate axes. For example, when the electronic device 250 is at rest, the accelerometer will only generate signal in the direction of Earth's gravitational field. Furthermore, if one of the axes of the 3D accelerometer 210 corresponds to the direction of the gravitation, the signal will be generated only along that axis. For example, a stationary electronic device 250 may be aligned against the surface of Earth to emit only g_{z} signal in the Z direction that is perpendicular to a reflective surface 220 (e.g., the screen of a smart phone or a tablet). With such an orientation, the reflective surface 220 is positioned as an artificial horizon 200.

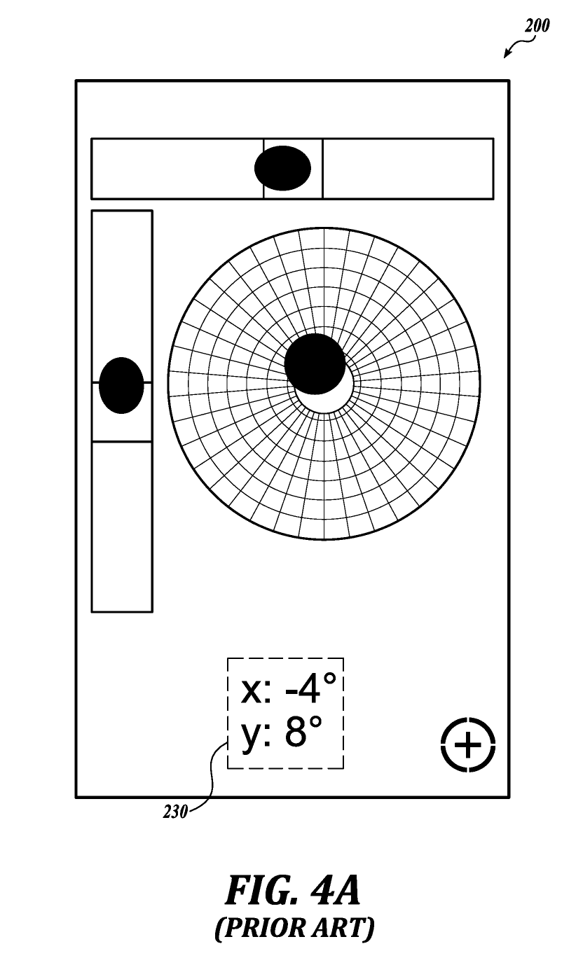

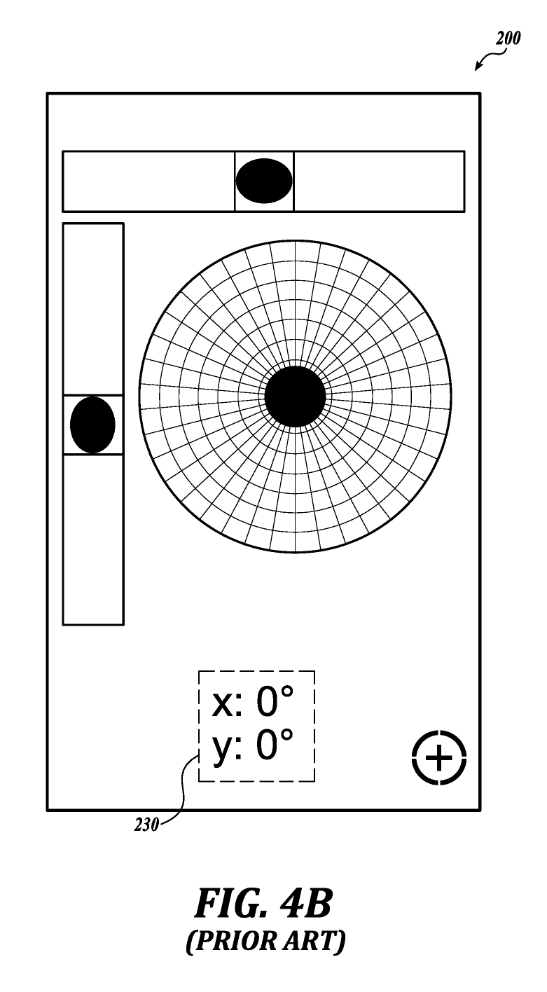

FIGS. 4A and 4B are schematic views of a level detector 230 in accordance with prior art technology. Many electronic devices can determine their own inclination based on the signals from their 3D accelerometer, and then display the value of the inclination on the screen using suitable apps. For example, the level detector in FIG. 4A shows that the device is inclined −4° in the X direction and 8° in the Y direction. The level detector 230 in FIG. 4B shows that device is essentially horizontal (e.g., the device is horizontal within the limits of available resolution of the level detector). Such horizontal device may be used as an artificial horizon.

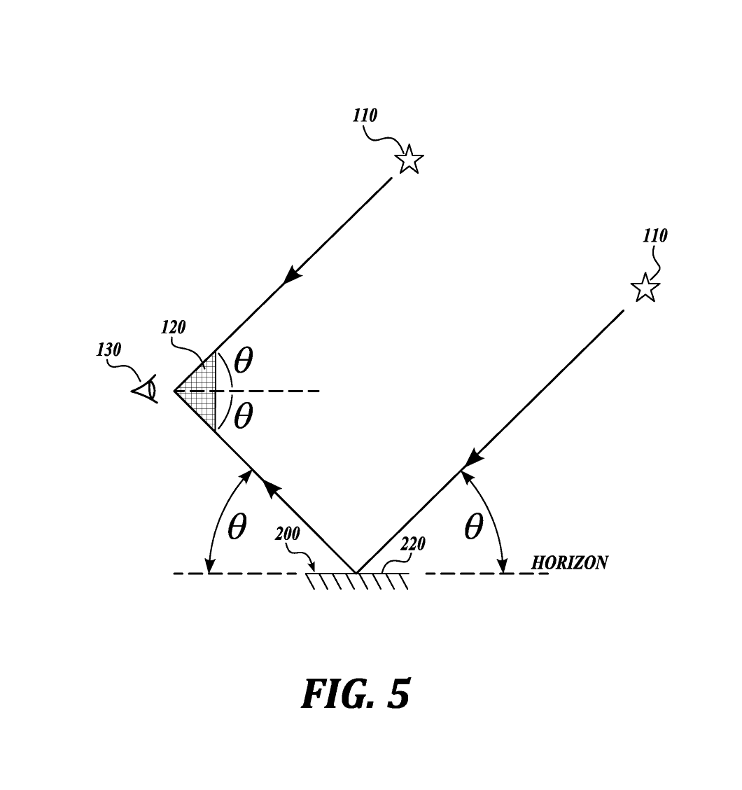

FIG. 5 is a schematic view of a location determination in accordance with embodiments of the presently disclosed technology. In operation, the operator 130 observes two images of the celestial body through sextant 120. In some embodiments, one of the images of the celestial body 110 corresponds to the celestial body 110, and the other image is reflected off the artificial horizon 200 (e.g., screen of a smart phone or a tablet) that is leveled horizontally. When the two images appear mutually aligned to the observer, the sextant 120 is oriented such that the angle indicator of the sextant 120 corresponds to the altitude angle θ. In some embodiments, the horizontal leveling of the artificial horizon 200 may be based on the accelerometer signal, as described with reference to, for example, FIGS. 3-4B above.

A sample, non-limiting measurement of the altitude angle θ is described below. A set of the measurements were taken using the Sun as a reference around 2:00 PM PDT, or 13:00 (minus the hour for daylight saving) on Sep. 13, 2016. The measured altitude angle was 77° 43.4′. This is the altitude of the Sun above the horizon. When that angle is divided by two we get 38° 51.7′.

Immediately prior to this measurement, an index correction was determined during a hot afternoon while the sextant was placed directly in the sun for hours. This reading was 1° 30′. This angle corresponds to the correction for the index mirror being misaligned due to heat expansion of the brass, and/or other errors of the instrument.

Next, the tabulated values in Table 1 were consulted for the relevant altitude angle. Referring to Table 1, the two left-hand columns after the Date and Hour of Day are the Greenwich Hour Angle in)degrees (°) and minutes (′) from the prime meridian, and Declination altitude in degrees (°) and minutes (′) for the Sun on the celestial sphere. At 2:00 PM PDT, the declination of the Sun is north 3° 30.2′ (north of the equator projected on the celestial sphere).

TABLE 1
Astronomical almanac for Sep. 13, 2016

| | | | | | | | | | | |
|---|---|---|---|---|---|---|---|---|---|---|
| TUESDAY | 1300 | 181 | 01.3 | N 3 | 42.6 | 49 | 35.8 | 9.4 | S16 | 26.1 |
| | 01 | 196 | 01.5 | | 41.7 | 64 | 04.2 | 9.4 | 16 | 21.1 |
| | 02 | 211 | 01.7 | | 40.7 | 78 | 32.6 | 9.4 | 16 | 16.1 |
| | 03 | 226 | 02.0 | . . . | 39.8 | 93 | 01.0 | 9.3 | 16 | 11.0 |
| | 04 | 241 | 02.2 | | 38.8 | 107 | 29.3 | 9.4 | 16 | 05.7 |
| | 05 | 256 | 02.4 | | 37.9 | 121 | 57.7 | 9.3 | 16 | 00.4 |
| | 06 | 271 | 02.6 | N 3 | 36.9 | 136 | 26.0 | 9.3 | S15 | 55.0 |
| | 07 | 286 | 02.8 | | 35.9 | 150 | 54.3 | 9.3 | 15 | 49.5 |
| | 08 | 301 | 03.1 | | 35.0 | 165 | 22.6 | 9.3 | 15 | 43.9 |
| | 09 | 316 | 03.3 | . . . | 34.0 | 179 | 50.9 | 9.2 | 15 | 38.1 |
| | 10 | 331 | 03.5 | | 33.1 | 194 | 19.1 | 9.3 | 15 | 32.3 |
| | 11 | 346 | 03.7 | | 32.1 | 208 | 47.4 | 9.2 | 15 | 26.4 |
| | 12 | 1 | 04.0 | N 3 | 31.1 | 223 | 15.6 | 9.2 | S15 | 20.4 |
| | 13 | 16 | 04.2 | | 30.2 | 237 | 43.8 | 9.2 | 15 | 14.3 |
| | 14 | 31 | 04.4 | | 29.2 | 252 | 12.0 | 9.2 | 15 | 08.2 |
| | 15 | 46 | 04.6 | . . . | 28.3 | 266 | 40.2 | 9.2 | 15 | 01.9 |
| | 16 | 61 | 04.9 | | 27.3 | 281 | 08.4 | 9.2 | 14 | 55.5 |
| | 17 | 76 | 05.1 | | 26.4 | 295 | 36.6 | 9.2 | 14 | 49.0 |

Therefore, the latitude of the observer can be calculated as the sextant measurement location:

90°−38° 51.7 ′−1° 30′−3° 30.2″=47° 8.1′

For this particular measurement, the observer was in Richland, Wash. which has the latitude of 46° 31′. Therefore, the measured latitude is reasonably close to the true latitude.

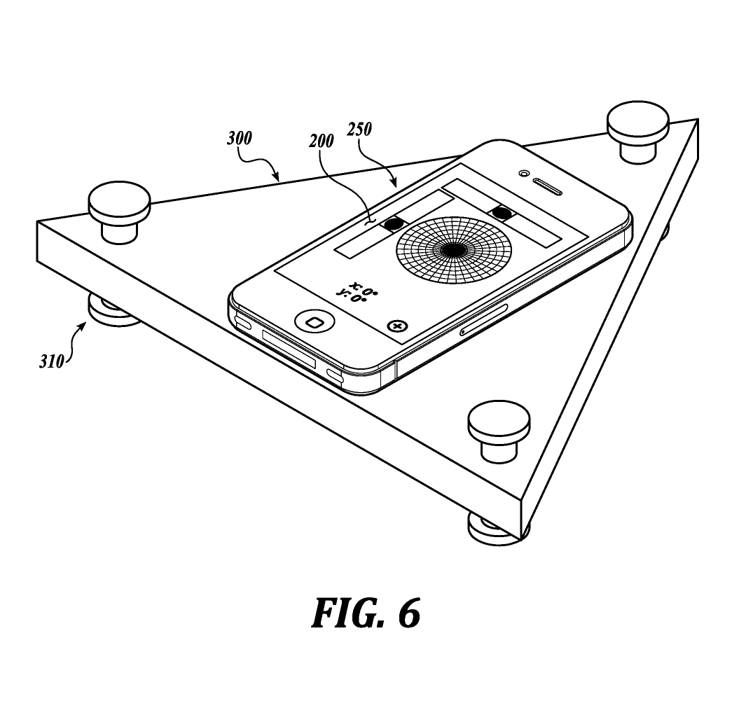

FIG. 6 is an isometric view of an artificial horizon in accordance with an embodiment of the presently disclosed technology. In some embodiments, the artificial horizon 200 may be created by placing the electronic device 250 one a leveler 300. In some embodiments, the leveler 300 may be adjusted by adjusting one or more feet 310 till the artificial horizon 200 indicates a horizontal position (e.g., X=0°, Y=0°.)

Many embodiments of the technology described above may take the form of computer- or controller-executable instructions, including routines executed by a programmable computer or controller. Those skilled in the art will appreciate that the technology can be practiced on computer/controller systems other than those shown and described below. The technology can be embodied in a special-purpose computer, controller, or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented by any suitable display medium, including a CRT display or LCD.

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Accordingly, the disclosure can encompass other embodiments not expressly shown or described herein.

I/We claim:

1. A method for determining a position of an observer, comprising:
establishing a horizontal position of an artificial horizon mirror based on at least one accelerometer;
aligning a sextant toward a celestial body; and
measuring an altitude angle of the celestial body at least in part based on a portion of light from the celestial body being reflected from the artificial horizon mirror onto the sextant.

2. The method of claim 1, wherein the artificial horizon mirror is a screen of a mobile device.

3. The method of claim 1, wherein the artificial horizon mirror is a reflective surface affixed to a mobile device.

4. The method of claim 3, wherein the at least one accelerometer is carried by the mobile device.

5. The method of claim 3, wherein the mobile device is a mobile phone.

6. The method of claim 3, wherein the mobile device is a tablet.

7. The method of claim 1, wherein the at least one accelerometer comprises a 3-axis MEM accelerometer.

8. The method of claim 1, further comprising determining a latitude and a longitude of the observer based on the altitude angle of the celestial body and a reference to predetermined positions of the celestial body.

9. The method of claim 1, wherein establishing the horizontal position of the artificial horizon mirror comprises:
placing the artificial horizon mirror on a leveler; and
adjusting an inclination of the leveler to bring the artificial horizon mirror onto the horizontal position.

10. A system for determining a position of an observer, comprising:
an artificial horizon mirror having a determinable horizontal position based on at least one accelerometer; and
a sextant configured to determine an altitude angle of the celestial body at least in part based on a portion of light from the celestial body being reflected from the artificial horizon mirror onto the sextant.

11. The system of claim 10, further comprising a leveler configured to bring the artificial horizon mirror into the horizontal position.

12. The system of claim 11, wherein the leveler comprises adjustable feet.

13. The system of claim 10, wherein the artificial horizon mirror is a screen of a mobile device.

14. The system of claim 13, wherein the mobile device is a mobile phone.

15. The system of claim 13, wherein the mobile device is a tablet.

16. The system of claim 13, wherein the at least one accelerometer is carried by the mobile device.

17. The system of claim 13, wherein the screen of the mobile device includes indicators of the horizontal position of the mobile device.

18. The system of claim 13, wherein the indicators of the horizontal position of the mobile device indicate that the positon of the mobile device is the horizontal position.

19. The system of claim 10, wherein the artificial horizon mirror is a reflective surface affixed to a mobile device.

20. The system of claim 10, wherein the at least one accelerometer comprises a 3-axis MEM accelerometer.
